(19) United States
(12) Patent Application Publication
(10) Pub. No.: US 2015/0254690 A1
(43) Pub. Date: Sep. 10, 2015

(54) ANALYZING A TRUST METRIC OF RESPONSES THROUGH TRUST ANALYTICS

(71) Applicant: International Business Machines Corporation, Armonk, NY (US)

(72) Inventors: Tian-Jy Chao, Bedford, NY (US); Younghun Kim, White Plains, NY (US); Sambit Sahu, Hopewell Junction, NY (US)

(73) Assignee: International Business Machines Corporation, Armonk, NY (US)

(21) Appl. No.: 14/201,081

(22) Filed: Mar. 7, 2014

(51) Int. Cl. G06Q 30/02

(52) U.S. Cl. CPC G06Q 30/0203; G06Q 30/0204

(57) ABSTRACT

A method, system and computer program product are disclosed for analyzing a specified trust metric of survey responses obtained in a campaign. In one embodiment, the method comprises parsing requirements and goals of the campaign to identify campaign specifics; mapping one or more of the identified campaign specifics to a trust metric calculation rule, the trust metric calculation rule including an algorithm for computing a value for the specified trust metric. The method further comprises using the trust metric calculation rule and one or more of the identified campaign specifics to filter a set of potential input attributes to select therefrom a subset of input attributes; obtaining data values for the subset of input attributes; and using the algorithm of the trust metric calculation rule and the obtained data values for the subset of input attributes to compute the value for the specified trust metric.

### BACKGROUND

This invention generally relates to analyzing answers or responses obtained in a campaign or survey, and more specifically to analyzing a trust metric, such as the accuracy or trustworthiness, of such answers or responses.

Campaigns or surveys, such as advertising campaigns, public service campaigns and marketing campaigns, are undertaken to obtain information or to persuade people to act in a certain way. For example, a marketing survey may be done in order to determine the public's interest in a potential product or service. A transportation survey may be taken to learn what changes the public wants in a public transportation system. A public service campaign may be undertaken to convince people to change their conduct, by for example, recycling more, reducing use of electricity, or using health services more effectively.

Different campaigns possess different characteristics (aka campaign specifics), e.g. campaign criteria, requirements of recruitment and goals, etc. If these characteristics are not dealt with specifically, campaigns can often be rendered ineffective. For instance, campaigns may be unable to reach the intended level of responses or to attract the appropriate types of people in the right geographic location or demographic group (e.g., age, education or income) for the campaign to be successful.

Ad hoc management of campaigns lacks a systematic analysis on the quality of data and inputs provided by campaign participants, which can compromise the quality and effectiveness of the campaigns.

### BRIEF SUMMARY

Embodiments of the invention provide a method, system and computer program product for analyzing a specified trust metric of survey responses obtained in a campaign having identified requirements and goals. In one embodiment, the method comprises parsing the requirements and goals of the campaign to identify campaign specifics; mapping one or more of the identified campaign specifics to a trust metric calculation rule, said trust metric calculation rule including an algorithm for computing a value for the specified trust metric. The method further comprises using the trust metric calculation rule and one or more of the identified campaign specifics to filter a set of potential input attributes to select therefrom a subset of input attributes; obtaining data values for the subset of input attributes; and using the algorithm of the trust metric calculation rule and the obtained data values for the subset of input attributes to compute the value for the specified trust metric.

In one embodiment, the set of potential input attributes includes a multitude of primary or core attributes and a multitude of secondary attributes; and the using the trust metric calculation rule and one or more of the identified campaign specifics to filter a set of potential input attributes to select therefrom a subset of input attributes includes using the trust metric calculation rule to identify one of the primary or core attributes, and using the one or more of the campaign specifics to select one or more of a group of secondary attributes.

In an embodiment, the parsing the requirements and goals of the campaign includes parsing, extracting, and processing campaign criteria and requirements, and goals from a plurality of input sources. Said criteria and requirements include resource restrictions for budget, staffing, time line/duration; said goals include increase the reliable responses, frequent responses, or responses from participants in a specific geographic location or demographic group, or with a job type or financial status, or have participated in prior similar campaigns; and said input sources include voice, text, user interface screens.

In an embodiment, the using the trust metric calculation rule and one or more of the identified campaign specifics to filter a set of potential input attributes to select therefrom a subset of input attributes includes using the trust metric calculation rule that is mapped to the requirements and goals to specify a subset of potential input attributes most relevant to the rule from the entire set of input attributes.

In one embodiment, the trust metric calculation rule comprises both the selected input attributes and an algorithm, which in terms comprises a name and a formula, for use to compute the trust metric of a participant using the selected input attributes.

In an embodiment, the primary or core attributes include: a user identification, and location and timestamp information, including, latitude, longitude and time; prior campaign responses, or information about responses from prior campaigns, including a response frequency, information about response quality, including accurate prior reporting, or picture quality, other data quality information, or information about a campaign context. The secondary attributes include: demographic information including age, occupation, education level; financial data including income, home ownership; transportation preferences, including preferences for public transit, bicycles, or cars; skills; ownership of devices including smart phones and appliances, and other devices; social network postings; smart meter data; data about natural resources, including water, electricity, gas; data provided by users, including HRA related data including questionnaire responses; and sensor-based data including data from smart phones.

In one embodiment, the mapping the requirements and goals of the campaign to a trust metric calculation rule includes mapping the requirements and goals of the campaign to one of a multitude of pre-defined trust metric calculation rules.

In an embodiment, the mapping the requirements and goals of the campaign to one of a multitude of pre-defined trust metric calculation rules includes, for each of the multitude of trust metric calculation rules: identifying user selected attributes and weights where a user selects each input attribute and assigns a corresponding weight to the attribute; identifying reliable responders where only validated entries of a participant are counted for the weight of said validated entries; identifying frequent responders where a most recent entry is counted more weight than a less recent entry, and the weights of all entry occurrences are summed; and identifying a geographic vicinity where locations closer to a target location are counted with more weights than locations further from the target location.

In one embodiment, the mapping the requirements and goals of the campaign to a trust metric calculation rule includes mapping the requirements and goals of the campaign to one of a multitude of trust metric calculation rules that are not pre-defined.

In an embodiment, said campaign is a current campaign, and the obtaining data values for the subset of input attributes includes obtaining values for the subset of input attributes from the current campaign; the obtaining data values for the subset of input attributes includes obtaining values for the subset of input attributes from a previous campaign; and the using the algorithm to compute the values for the specified trust metric includes computing a value for the trust metric for each of a plurality of participants in the campaign, and ranking the values computed for the trust metrics for said plurality of participants.

In one embodiment, the algorithm to compute the values for the specified trust metric is pre-determined by the corresponding Trust Metric Calculation Rule mapped to the requirements and goals of the campaign. User selected attributes and weights rule uses the algorithm of weighted linear sum; reliable responders rule and frequent responders rule both use the algorithm of autoregressive moving average (AR); and geographic vicinity rule uses the algorithm of Euclidean distance plus travel distance.

In one embodiment of the invention, the method further comprises identifying a plurality of values in a time series for the campaign, using the trust metric calculation rule to predict subsequent values in the time series, identifying a specified parameter of the campaign, and

using the trust metric calculation rule to increase a value for said specified parameter.

In an embodiment, the survey responses are from a plurality of survey participants, and the using the algorithm of the trust metric calculation rule includes using the trust metric calculation rule to determine a defined level of trustworthiness of each of the participants.

In one embodiment, the method further comprises analyzing and aggregating the survey responses based on each of the participants' level of trustworthiness; and each of the participants' level of trustworthiness is determined using one or more defined criteria, said one or more defined criteria selected from the group comprising: reliability of the participant, responsiveness of the participant, prior experience of the participant, and prior survey activities of the participant.

Embodiments of the invention provide a method and apparatus for effectively analyzing the accuracy and trustworthiness of the responses and survey answers of campaign participants to improve the quality of the campaign responses. This analyzing and improvement is achieved through Trust Analytics.

Trust Analytics, generally, is used to analyze the quality of participant input and link that input to participant reputation to create varying degrees of trust in crowd-sensed data. Trust Analytics is discussed in detail in U.S. Patent Application Ser. No. 61/807,087, filed Apr. 1, 2013, the entire contents and disclosure of which are hereby incorporated herein by reference.

In embodiments of the invention, Trust Analytics is used by mapping to a trust metric calculation rule, and using that trust metric calculation rule for selecting the best input attributes and executing the appropriate analytics algorithm. This appropriate analytics algorithm is based on the campaign specifics, e.g., campaign criteria, requirements of recruitment and goals, and is defined by a campaign owner. In embodiment of the invention, the analytics algorithm uses both past historical data and current input to predict and ensure the best result of new data to improve campaign effectiveness.

### BRIEF DESCRIPTION OF THE SEVERAL VIEWS OF THE DRAWINGS

FIG. 1 illustrates a Trust Metric Calculation Rule in an embodiment of the invention.

FIG. 2 shows the overall flow of a trust metric computation in accordance with an embodiment of the invention.

FIG. 3 depicts a group of Trust Metric Calculation Rules.

FIG. 4 shows information about the algorithms of the Trust Metric Calculation rules shown in FIG. 3.

FIG. 5 illustrates a computing environment that may be used to implement embodiments of this invention.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments of the invention provide a method and apparatus for analyzing a specified trust metric, such as the accuracy or trustworthiness, of the responses and survey answers of campaign participants to improve the quality of the campaign responses. This analyzing and improvement is achieved through Trust Analytics by mapping to a trust metric calculation rule, and using that trust metric calculation rule for selecting the best input attributes and executing the appropriate analytics algorithm. This appropriate analytics algorithm is based on the campaign specifics, e.g., campaign criteria, requirements of recruitment and goals, and is defined by a campaign owner. In embodiment of the invention, the analytics algorithm uses both past historical data and current input to predict and ensure the best result of new data to improve campaign effectiveness.

Based on the existing campaign data (in a time series) and the current data, embodiments of the invention may be used to predict and ensure the best outcome of campaigns. As one example, embodiments of the invention may be used to predict the next value in a time series for a targeted campaign, such as a campaign for electricity conservation, health or wellness improvement, to persuade consumers to switch to gas stoves, etc. As another example, embodiments of the invention may be used to predict how best to increase the desired values in a time series for a campaign to improve the effectiveness of the campaign. This may be done by predicting how to increase positive response, or to get more responses from a particular geographic location, age group, or income level, etc.

Campaign criteria or goals may be, for example, to weigh the reliable responses more, to weigh the most recent responses more, or to give more weight to the responses of participants who live closest to a specified location. As another example, a campaign criteria or goal may be to weigh the responses of people who have jobs in transportation, and for instance, a weight of 0.4 may be assigned to these responses. As another example, a campaign criteria or goal may be to weigh responses of people who live in a specific district, and to assign a weight of 0.3 to these responses. Another campaign criteria may be to give more weight to responses of people who participated in prior citizen engagements, and a weight of 0.5 may be assigned to these responses.

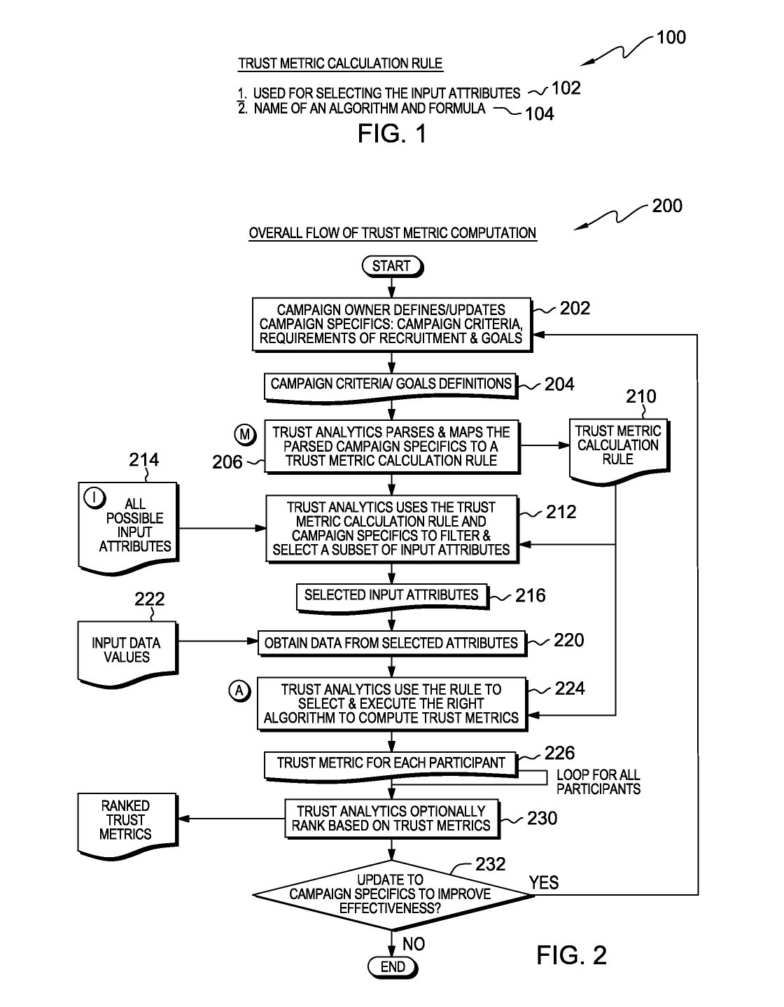

With reference to FIG. 1, a Trust Metric Calculation Rule 100 is comprised of two parts and is used to calculate a trust metric. The first part 102 of the Rule is used to select input attributes. The second part 104 of the Rule includes the name of an algorithm and a formula for using the selected input attributes to calculate the trust metric.

As example, the first part of a Trust Metric Calculation Rule may indicate that user selected attributes and weights are to be used in the algorithm. In this case, the user selects each attribute and assigns a corresponding weight to the attribute. As another example, the first part of a Trust Metric Calculation Rule may indicate that the selected input attributes are reliable responders. In this case, only validated entries—that is, entries validated as being from reliable responders—are counted for their weights (not just the occurrence of the entry).

As additional examples, the first part of a Trust Metric Calculation Rule may indicate that the selected input attributes are frequent responders, or responders in a specified geographical vicinity. In the case of frequent responders, more weight may be given to the most recent responses from a particular frequent responder; and, for example, the algorithm sums the weights of all the occurrences of responses from the responder. In the case of geographical vicinity, embodiments of the invention weight a location that is closer to the target more. For instance, more weight may be given to responses from responders who are at a location closer to the target.

In embodiments of the invention, possible input attributes include primary or core attributes, and secondary attributes. Primary or core attributes may include, for example, a user identification, and location and timestamp information, e.g., latitude, longitude and time. Primary or core attributes may also include prior campaign responses, or information about responses from prior campaigns. This information may include a response frequency, information about response quality, e.g., accurate prior reporting, or picture quality, other data quality information, or information about a campaign context.

Secondary attributes may include, for example, demographic information such as age, occupation, education level, financial data (e.g., income, home ownership), transportation preferences (public transit, bicycles, or cars, etc.), skills, ownership of devices (e.g., smart phones and appliances, and others, etc.). Secondary attributes may also include network postings, e.g., textual input such as affirmative postings toward environmental sustainability. Also, for some campaigns, secondary attributes may include smart meter data and data about natural resources, e.g., water, electricity, gas, etc. For some campaigns, secondary attributes may include other data provided by users, e.g., HRA related data such as questionnaire responses, and sensor-based data such as data from smart phones, etc.

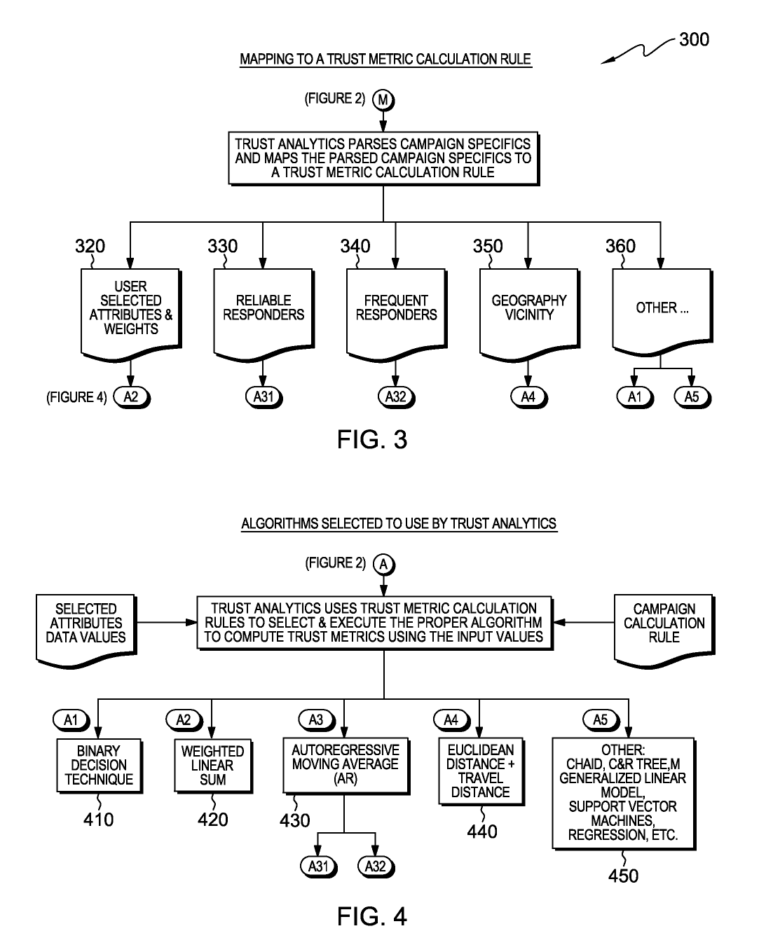

FIG. 2 illustrates the overall flow of a trust metric computation 200. At step 202, the campaign owner defines or updates campaign specifics; and this may include, for example, campaign criteria, recruitment requirements, and goals. Step 204 is to define the campaign criteria and/or goals. At step 206, Trust Analytics is used to parse the campaign specifics and to map the parsed campaign specifics to a Trust Metric Calculation rule, represented at 210.

The selected Trust Metric Calculation Rule and parsed campaign specifics are, at 212, used to filter a set 214 of potential input attributes to select a therefrom subset of the input attributes, represented at 216. At step 220, data is obtained for the selected attributes. In an embodiment of the invention, the Trust Metric Calculation Rule defines or identifies one or more of the input attributes, and parsed campaign specifics are used to select one or more additional input attributes. For example, the Trust Metric Calculation Rule may identify one of the primary input attributes, and the campaign specifics may be used to select one or more of the secondary inputs.

This data may include both historical data and current data that were obtained using the selected attributes, and this data may be obtained from one or more of any suitable data sources or data stores, represented at 222.

At step 224, the Trust Metric Calculation Rule is used to select and apply the algorithm to compute the trust metric or metrics from the selected attribute values. As represented at 226, the trust metric may be computed for each of a plurality of participants in the campaign. The trust metrics may be ranked at 230. As represented at 232, the process 200 may be repeated if the campaign specifics are updated or modified.

In the above-described flow, a subset of the input attributes are selected from 214 (all possible attributes) based on the Trust Metric Calculation Rule and parsed campaign specifics 206.

For example, the campaign goal is as follows: want to improve frequency of participation in the electricity conservation campaign from females over 65 years living in South West of the town.

The “parsed campaign specifics” would include these four:
Frequency (mapped to ‘Frequent Responder’ Trust Metric Calculation Rule),
Female (selecting ‘gender’ 2^{nd}-ary attribute),
>65 yr (for selecting ‘age’ 2^{nd} -ary attribute),
South West of the town (for selecting ‘location’ primary attribute).

Input data values 220 are the data values from the selected input attributes. In the example above, the attributes are gender, age, and location. The data values of a participant may be: female, 68 years, and the address is 55 Main Street, South West of the town.

FIG. 3 illustrates a procedure 300 for mapping to a Trust Metric Calculation Rule. In embodiments of the invention, a user provides or identifies a series of Trust Metric Calculation Rules, each of which includes a name and an algorithm. FIG. 3 depicts a group of rules referred to as “user selected attributes and weights” 320, “reliable responders” 330, “frequent responders” 340, and “geographic vicinity” 350. Other Rules, represented at 360, may also be provided. As mentioned above, in the process of FIG. 2, at step 224, Trust Analytics parses campaign specifics and maps the parsed campaign specifics to a Trust Metric Calculation Rule.

FIG. 4 shows more information about the algorithms of the Trust Metric Calculation Rules illustrated in FIG. 3. The algorithm of the “user selected attributes and weights” Rule 320 is a weighted linear sum algorithm 420, and the algorithm of the “Reliable Responders” rule 330 is based on an autoregression moving average 430. The algorithm of the “Frequent Responders” rule 340 is based on an auto regressive moving average 430, and the algorithm of the “Geographic Vicinity” rule 350 is based on Euclidean distance plus a travel distance 440. In an embodiment of the invention, the user selects the weights for the user selected attributes. Other than the “user selected attributes and weights,” where a user decides on the weight of each attribute selected, a Trust Metric Calculation Rule selects or determines the weights for the input attributes defined or identified by the Trust Metric Calculation Rule.

As is apparent to those of ordinary skill in the art, many other types of algorithms may also be used in embodiments of this invention. For instance, as shown at 450, these algorithms may include CHAID or C & R Tree. Also, the algorithms may be Generalized Linear Models, may use Support Vector Machines, or may be Regression based algorithms.

Given below are four examples of Trust Metric Calculation Rules.

1. User Selected attributes and weights 320.
Input Attributes: selected attribute, e.g. job, location, taking mass transit, etc. and a corresponding weight assigned to each attribute, and UID
Algorithm:
   Name: Weighted Linear Sum 420
   Algorithm formula:

$${\sum }_{j = 1}^{3 ( total attributes )} Weight ( j ) * attribute ( j )$$

Where n=total attributes

2. Reliable responders 330
Example
Input Attributes: reliable posting flag (t), timestamp, UID
Algorithm.
   Name: Autoregressive moving average (AR) 430
   Algorithm formula:

$${\sum }_{t = today - 60 days}^{today} Weight ( t ) * reliable posting flag ( t )$$

(where t represents the day for 2 months back)

3. Frequent responders 340.
Example
Input: Attributes: posting frequency, timestamp, UID
Algorithm:
   Name: Autoregressive moving average (AR) 430
   Algorithm formula:

$${\sum }_{T = today - 60 days}^{today} Weight ( t ) * frequency of posting ( t )$$

(where t represents the day for 2 month back)

4. Geographic Vicinity 350

Input Attributes: selected attribute, e.g., job, location, taking mass transit etc. and corresponding weight assigned to each attribute, UID

Algorithm:
Name: Euclidean distance+travel distance 440
Algorithm formula: [symbol]
Together with information about route segment and length.

Presented below are several examples of the use of Trust Metric Calculation Rules to select a subset of attributes from a given or defined set of potential input attributes, and an algorithm to compute the trust metrics using the selected attributes.

1. Campaign criteria/goals: Consolidate inputs from citizens of best practices on energy/water savings activities

Trust Metric Calculation Rule: User selected attributes & weights
Attributes selected: Location, smart meter ownership, participation in the prior pilot programs, and how participants responded to the prior campaigns,
Algorithm selected: Weighted Linear Sum to assign higher trust value to participants who have participated in smarter energy/water pilots campaigns and achieved greater than 6% of savings before vs. after the pilots.
   2. Campaign criteria/goals: Run a neighborhood watch campaign and weight the reliable responses more

### Trust Metric Calculation Rule: Reliable Responders

Attributes selected: participants' response intervals & frequency (e.g. once a day, every other day), home addresses, and prior neighborhood watch reports with validation
Algorithm selected: Autoregressive moving average (AR) to assign each occurrence an equal weight and sum up multiple occurrence to be the final score to calculate the frequency of a participant's response rate, and rank the participants by the score if the prior responses were valid.
   Example: A user reported 3 occurrences recently of incidents a, b, c, with values of 1 1 1 respectively, and the corresponding validation flags are 0 0 1 which means that only the last report or ‘c’ occurrence was validated to be a true report.

3/10*a*0+ 3/10*b*0+ 3/10*c*1=0.3 Algorithm used:
Trust metrics is 0.3 (only last report, i.e. c occurrence, is counted with a weight of 0.3).
   3. Campaign criteria/goals: Run a most recent status of curbside walkability in a targeted neighborhood and weight the most recent responses more.

### Trust Metric Calculation Rule: Frequent Responders.

Attributes selected: participants' response intervals & frequency (e.g. once a day, every other day), home addresses
Algorithm selected: Autoregressive moving average (AR).
Example: 3 occurrences of incidents a, b, c with values of 1 0 1 respectively.

1/10*a+ 3/10*b+ 6/10*c=0.7 Algorithm formula used:

Trust metrics is 0.7 (i.e., occurrence a with a weight of 0.1 and occurrence ‘c’ with a weight of 0.6 are counted, and the most recent occurrence ‘c’, has the most weight of 0.6).

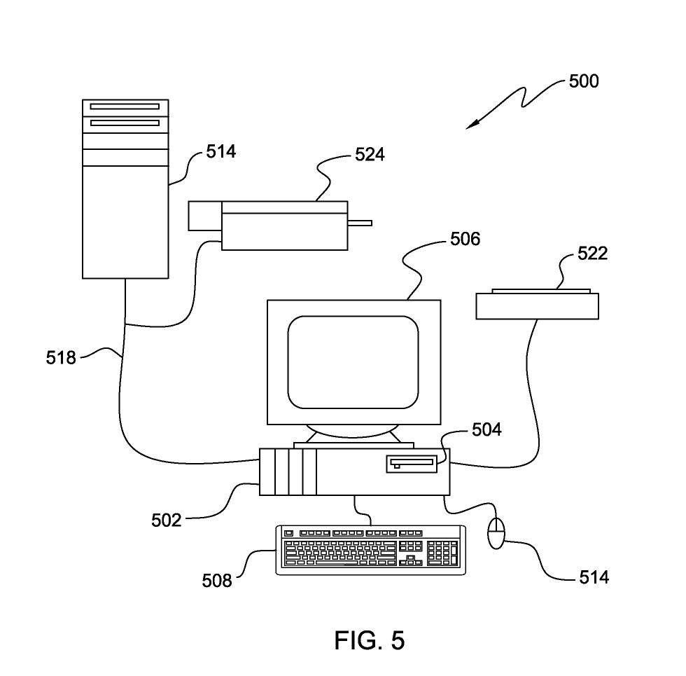

A computer-based system 500 in which a method embodiment of the invention may be carried out is depicted in FIG. 5. The computer-based system 500 includes a processing unit 502, which houses a processor, memory and other systems components (not shown expressly in the drawing) that implement a general purpose processing system, or computer that may execute a computer program product. The computer program product may comprise media, for example a compact storage medium such as a compact disc, which may be read by the processing unit 502 through a disc drive 504, or by any means known to the skilled artisan for providing the computer program product to the general purpose processing system for execution thereby.

The computer program product may comprise all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 502, as mentioned, or may be located on a remote system such as a server 514, coupled to processing unit 502, via a network interface 518 such as an Ethernet interface. Monitor 506, mouse 514 and keyboard 508 are coupled to the processing unit 502, to provide user interaction. Scanner 524 and printer 522 are provided for document input and output. Printer 522 is shown coupled to the processing unit 502 via a network connection, but may be coupled directly to the processing unit. Scanner 524 is shown coupled to the processing unit 502 directly, but it should be understood that peripherals might be network coupled, or direct coupled without affecting the performance of the processing unit 502.

While it is apparent that embodiments of the invention herein disclosed are well calculated to achieve the features discussed above, it will be appreciated that numerous modifications and embodiments may be devised by those skilled in the art, and it is intended that the appended claims cover all such modifications and embodiments as fall within the true spirit and scope of the present invention.

1. A method of analyzing a specified trust metric of survey responses obtained in a campaign having identified requirements and goals, the method comprising:
parsing the requirements and goals of the campaign to identify campaign specifics;
mapping one or more of the identified campaign specifics to a trust metric calculation rule, said trust metric calculation rule including an algorithm for computing a value for the specified trust metric;
using the trust metric calculation rule and one or more of the identified campaign specifics to filter a set of potential input attributes to select therefrom a subset of input attributes;
obtaining data values for the subset of input attributes; and
using the algorithm of the trust metric calculation rule and the obtained data values for the subset of input attributes to compute the value for the specified trust metric.

2. The method according to claim 1, wherein:
the set of potential input attributes includes a multitude of primary or core attributes and a multitude of secondary attributes; and
the using the trust metric calculation rule and one or more of the identified campaign specifics to filter a set of potential input attributes to select therefrom a subset of input attributes includes using the trust metric calculation rule to identify one of the primary or core attributes, and
using the one or more of the campaign specifics to select one or more of a group of secondary attributes.

3. The method according to claim 1, wherein the parsing the requirements and goals of the campaign includes:
parsing, extracting, and processing campaign criteria and requirements, and goals from a plurality of input sources, and wherein:
said criteria and requirements include resource restrictions for budget, staffing, time line/duration,
said goals include increase the reliable responses, frequent responses, or responses from participants in a specific geographic location or demographic group, or with a job type or financial status, or have participated in prior similar campaigns, and
said input sources include voice, text, user interface screens.

4. The method according to claim 1, wherein the using the trust metric calculation rule and one or more of the identified campaign specifics to filter a set of potential input attributes to select therefrom a subset of input attributes includes:
using the trust metric calculation rule that is mapped to the requirements and goals to specify a subset of potential input attributes most relevant to the rule from the entire set of input attributes.

5. The method according to claim 1, wherein the trust metric calculation rule comprises both the selected input attributes and an algorithm, which in terms comprises a name and a formula, for use to compute the trust metric of a participant using the selected input attributes.

6. The method according to claim 5, wherein:
the primary or core attributes include
a user identification, and location and timestamp information, including, latitude, longitude and time,
prior campaign responses, or information about responses from prior campaigns, including a response frequency, information about response quality, including accurate prior reporting, or picture quality, other data quality information, or information about a campaign context, and
the secondary attributes include
demographic information including age, occupation, education level,
financial data including income, home ownership,
transportation preferences, including preferences for public transit, bicycles, or cars,
skills,
ownership of devices including smart phones and appliances, and other devices, social network postings,
smart meter data,
data about natural resources, including water, electricity, gas,
data provided by users, including HRA related data including questionnaire responses, and sensor-based data including data from smart phones.

7. The method according to claim 1, wherein the mapping the requirements and goals of the campaign to a trust metric calculation rule includes:
mapping the requirements and goals of the campaign to one of a multitude of pre-defined trust metric calculation rules.

8. The method according to claim 7, wherein the mapping the requirements and goals of the campaign to one of a multitude of pre-defined trust metric calculation rules includes, for each of the multitude of trust metric calculation rules:
identifying user selected attributes and weights where a user selects each input attribute and assigns a corresponding weight to the attribute;
identifying reliable responders where only validated entries of a participant are counted for the weight of said validated entries;
identifying frequent responders where a most recent entry is counted more weight than a less recent entry, and the weights of all entry occurrences are summed; and
identifying a geographic vicinity where locations closer to a target location are counted with more weights than locations further from the target location.

9. The method according to claim 1, wherein the mapping the requirements and goals of the campaign to a trust metric calculation rule includes:
mapping the requirements and goals of the campaign to one of a multitude of trust metric calculation rules that are not pre-defined.

10. The method according to claim 1, wherein:
said campaign is a current campaign, and the obtaining data values for the subset of input attributes includes obtaining values for the subset of input attributes from the current campaign;
the obtaining data values for the subset of input attributes includes obtaining values for the subset of input attributes from a previous campaign; and
the using the algorithm to compute the values for the specified trust metric includes computing a value for the trust metric for each of a plurality of participants in the campaign, and ranking the values computed for the trust metrics for said plurality of participants.

11. The method according to claim 10, wherein the algorithm to compute the values for the specified trust metric is pre-determined by the corresponding Trust Metric Calculation Rule mapped to the requirements and goals of the campaign, and wherein:
user selected attributes and weights rule uses the algorithm of weighted linear sum;
reliable responders rule and frequent responders rule both use the algorithm of autoregressive moving average (AR); and
geographic vicinity rule uses the algorithm of Euclidean distance plus travel distance.

12. The method according to claim 1, further comprising:
identifying a plurality of values in a time series for the campaign;
using the trust metric calculation rule to predict subsequent values in the time series;
identifying a specified parameter of the campaign; and
using the trust metric calculation rule to increase a value for said specified parameter.

13. The method according to claim 1, wherein:
the survey responses are from a plurality of survey participants; and
the using the algorithm of the trust metric calculation rule includes using the trust metric calculation rule to determine a defined level of trustworthiness of each of the participants.

14. The method according to claim 13, further comprising:
analyzing and aggregating the survey responses based on each of the participants' level of trustworthiness; and wherein:
each of the participants' level of trustworthiness is determined using one or more defined criteria, said one or more defined criteria selected from the group comprising: reliability of the participant, responsiveness of the participant, prior experience of the participant, and prior survey activities of the participant.

15. A system for analyzing a specified trust metric of survey responses obtained in a campaign having identified requirements and goals, the system comprising:
one or more processor units configured for:
receiving input identifying a trust metric calculation rule, said trust metric calculation rule being mapped from one or more identified campaign specifics, and said trust metric calculation rule including an algorithm for computing a value for the specified trust metric;
receiving input identifying a subset of attributes of a set of potential input attributes, said subset of input attributes being selected from the set of potential input attributes by using the trust metric calculation rule and one or more campaign specifics;
receiving input specifying data values for the subset of input attributes; and
using the algorithm of the trust metric calculation rule and the received data values for the subset of input attributes to compute the value for the specified trust metric.

16. The system according to claim 15, wherein:
said campaign is a current campaign, and the obtaining data values for the subset of input attributes includes obtaining values for the subset of input attributes from the current campaign; and
the obtaining data values for the subset of input attributes includes obtaining values for the subset of input attributes from a previous campaign.

17. The system according to claim 15, wherein:
the using the algorithm to compute the values for the specified trust metric includes, computing a value for the trust metric for each of a plurality of participants in the campaign, and ranking the values computed for the trust metrics for said plurality of participants;
the survey responses are from a plurality of survey participants; and
the using the algorithm of the trust metric calculation rule includes using the trust metric calculation rule to determine a defined level of trustworthiness of each of the participants, and analyzing and aggregating the survey responses based on each of the participants' level of trustworthiness.

18. An article of manufacture comprising:
at least one tangible computer readable medium having computer readable program code logic for analyzing a specified trust metric of survey responses obtained in a campaign having identified requirements and goals, the computer readable program code logic, when executing, performing the following:
receiving input identifying a trust metric calculation rule, said trust metric calculation rule being mapped from one or more identified campaign specifics, and said trust metric calculation rule including an algorithm for computing a value for the specified trust metric;
receiving input identifying a subset of attributes of a set of potential input attributes, said subset of input attributes being selected from the set of potential input attributes by using the trust metric calculation rule and one or more campaign specifics;
receiving input specifying data values for the subset of input attributes; and
using the algorithm of the trust metric calculation rule and the received data values for the subset of input attributes to compute the value for the specified trust metric.

19. The article of manufacture according to claim 18, wherein:
said campaign is a current campaign, and the obtaining data values for the subset of input attributes includes obtaining values for the subset of input attributes from the current campaign;
the obtaining data values for the subset of input attributes includes obtaining values for the subset of input attributes from a previous campaign; and
the using the algorithm to compute the values for the specified trust metric includes computing a value for the trust metric for each of a plurality of participants in the campaign, and ranking the values computed for the trust metrics for said plurality of participants.

20. The article of manufacture according to claim 18, wherein:
the survey responses are from a plurality of survey participants; and
the using the algorithm of the trust metric calculation rule includes using the trust metric calculation rule to determine a defined level of trustworthiness of each of the participants, and analyzing and aggregating the survey responses based on each of the participants' level of trustworthiness.
